(19) United States
(12) Patent Application Publication
(10) Pub. No.: US 2026/0207989 A1
(43) Pub. Date: Jul. 23, 2026

(54) SMART MAT AND MULTI-POINT DETECTION METHOD FOR SMART MAT

(71) Applicant: Zhangzhou Solex Smart Home Co., Ltd., Zhangzhou City (TW)

(72) Inventors: Hongwei ZHU, Zhangzhou City (CN); Liangrong QIU, Zhangzhou City (CN); Jincong KANG, Zhangzhou City (CN)

(21) Appl. No.: 19/567,674

(22) Filed: Mar. 16, 2026

Related U.S. Application Data
(63) Continuation-in-part of application No. PCT/CN2024/115165, filed on Aug. 28, 2024.

(30) Foreign Application Priority Data
Sep. 15, 2023 (CN) 202311195487.9

(51) Int. Cl. A63B 21/00; G01L 1/22

(52) U.S. Cl. CPC A63B 21/4037; G01L 1/22; A63B 2220/56; A63B 2225/20

(57) ABSTRACT

A smart mat includes a first surface layer, a second surface layer, a pressure sensing layer, and a detection module. The pressure sensing layer is located between the first surface layer and the second surface layer, and the pressure sensing layer includes a first electrode layer, a conductive layer, and a second electrode layer. The first electrode layer includes a plurality of first conductive wires, and the second electrode layer includes a plurality of second conductive wires. The first direction intersects the second direction. The conductive layer includes a plurality of conductive strips extending along the first direction and spaced apart from each other, and the plurality of conductive strips correspond to the plurality of first conductive wires in a one-to-one correspondence. The detection module is respectively connected to the plurality of first conductive wires and the plurality of second conductive wires.

### RELATED APPLICATIONS

This application is a continuation-in-part of International patent application number PCT/CN 2024/115165, filed on Aug. 28, 2024, which claims priority to Chinese patent application number 202311195487.9, filed on Sep. 15, 2023. International patent application number PCT/CN2024/115165 and Chinese patent application number 202311195487.9 are incorporated herein by reference.

### FIELD OF THE DISCLOSURE

The present disclosure relates to the technical field of smart mats, and in particular to a smart mat and a multi-point detection method for the smart mat.

### BACKGROUND OF THE DISCLOSURE

With the continuous improvement of people's living standards, more and more people are beginning to focus on physical exercise, such as working out on fitness mats (yoga mats, dance mats). However, due to insufficient mastery of relevant movements by exercisers, it is easy for them to perform movements that are not standard enough, or even to make wrong movements. In mild cases, this can cause muscle or bone damage to the exerciser. In severe cases, it can lead to serious injury. Another example is that people nowadays, due to factors such as high work intensity and high stress, are paying more and more attention to sleep quality. When resting and sleeping on a mattress, they need to understand their own sleep quality.

To guide an exerciser to perform relevant movements accurately when using a smart fitness mat, the stressed positions on the smart fitness mat can be located, and then the located stressed positions can be compared with reference positions to assist the user in judging the accuracy of the current position. Alternatively, to sense the position of a human body on a mattress, the stressed positions on a smart sensing mattress can be located, and then the located stressed positions can be analyzed to obtain a sleep situation of the user. Therefore, there is an urgent need for a smart sensing mat with a positioning function and high positioning accuracy.

### BRIEF SUMMARY OF THE DISCLOSURE

An objective of an embodiment of the present disclosure is to provide a smart mat and a multi-point detection method for the smart mat, which improve the positioning accuracy of the smart mat.

Other features and advantages of the present disclosure will become apparent from the following detailed description, or may be learned in part by practice of the present disclosure.

According to one perspective of the present disclosure, a smart mat is provided, and the smart mat comprises a first surface layer, a second surface layer, a pressure sensing layer, and a detection module.

The first surface layer and the second surface layer are disposed opposite to each other.

The pressure sensing layer is located between the first surface layer and the second surface layer, and the pressure sensing layer comprises a first electrode layer, a conductive layer, and a second electrode layer stacked sequentially. The first electrode layer comprises a plurality of first conductive wires extending along a first direction and spaced apart from each other, and the second electrode layer comprises a plurality of second conductive wires extending along a second direction and spaced apart from each other. The first direction intersects the second direction, and the conductive layer comprises a plurality of conductive strips extending along the first direction and spaced apart from each other. The plurality of conductive strips correspond to the plurality of first conductive wires in a one-to-one correspondence.

The detection module is respectively connected to the plurality of first conductive wires and the plurality of second conductive wires, and the detection module is configured to input a detection signal to the plurality of first conductive wires one by one and obtain an electrical signal from the plurality of second conductive wires, thereby outputting a position signal of a corresponding one of the plurality of first conductive wires and a corresponding one of the plurality of second conductive wires where the electrical signal changes.

In one exemplary embodiment of this disclosure, the detection module input the detection signal to the plurality of first conductive wires one by one through, within a detection cycle, the detection module inputting a high-level signal to the plurality of first conductive wires one by one and inputting a low-level signal to remaining ones of the plurality of first conductive wires other than one of the plurality of first conductive wires input with the high-level signal.

In one exemplary embodiment of this disclosure, the detection module comprises a plurality of acquisition terminal circuits, and the plurality of acquisition terminal circuits are connected to the plurality of second conductive wires in a one-to-one correspondence. The plurality of acquisition terminal circuits comprise a plurality of first selection switches, and the plurality of first selection switches comprise a plurality of throw terminals, a plurality of first wire connecting terminals, and a plurality of second wire connecting terminals. The plurality of throw terminals are connected to the plurality of second conductive wires, and the plurality of first wire connecting terminals are configured to be connected to a sampling circuit. The plurality of second wire connecting terminals are grounded.

In one exemplary embodiment of this disclosure, the plurality of acquisition terminal circuits also comprise a plurality of sample hold capacitors. First terminals of the plurality of sample hold capacitors are connected to the plurality of second conductive wires and the plurality of throw terminals, and second terminals of the plurality of sample hold capacitors are grounded.

In one exemplary embodiment of this disclosure, the plurality of acquisition terminal circuits also comprise a plurality of sampling resistors. First ends of the plurality of sampling resistors are connected to the plurality of second conductive wires and the plurality of throw terminals, and second ends of the plurality of sampling resistors are grounded.

In one exemplary embodiment of this disclosure, the detection module comprises a plurality of second selection switches. The plurality of second selection switches are connected to the plurality of first conductive wires, and the plurality of second selection switches comprise a plurality of throw terminals. A plurality of first wire connecting terminals, and a plurality of second wire connecting terminals, and the plurality of throw terminals are connected to the plurality of second conductive wires. The plurality of first wire connecting terminals are configured to be connected to a drive circuit, and the plurality of second wire connecting terminals are grounded.

In one exemplary embodiment of this disclosure, the smart mat comprises a communication module.

The communication module is connected to the detection module, and the communication module is configured to transmit detection data obtained by the detection module to a target terminal.

In one exemplary embodiment of this disclosure, lengths of the plurality of first conductive wires along the first direction are greater than lengths of the plurality of second conductive wires along the second direction.

In one exemplary embodiment of this disclosure, a number of the plurality of conductive strips is the same as that of the plurality of first conductive wires.

In one exemplary embodiment of this disclosure, the conductive layer is a conductive carbon film, and the conductive carbon film is divided into a plurality of conductive carbon strips to serve as the plurality of conductive strips.

According to another one perspective of the present disclosure, a multi-point detection method for a smart mat is provided. The multi-point detection method comprises:
providing the smart mat, wherein the smart mat comprises a first surface layer, a second surface layer, a pressure sensing layer, and a detection module, the first surface layer and the second surface layer are disposed opposite to each other, the pressure sensing layer is located between the first surface layer and the second surface layer, the pressure sensing layer comprises a first electrode layer, a conductive layer, and a second electrode layer stacked sequentially, the first electrode layer comprises a plurality of first conductive wires extending along a first direction and spaced apart from each other, the second electrode layer comprises a plurality of second conductive wires extending along a second direction and spaced apart from each other, the first direction intersects the second direction, the conductive layer comprises a plurality of conductive strips extending along the first direction and spaced apart from each other, the plurality of conductive strips correspond to the plurality of first conductive wires in a one-to-one correspondence, and the detection module is respectively connected to the plurality of first conductive wires and the plurality of second conductive wires;
obtaining a standard electrical signal of a detection point formed between the plurality of first conductive wires and the plurality of second conductive wires by the detection module when the smart mat is not pressed;
in one detection cycle, inputting a detection signal to one of the plurality of first conductive wires through the detection module, obtaining, through the detection module, one of the plurality of second conductive wires whose electrical signal changes among the plurality of second conductive wires and the one of the plurality of first conductive wires that is input with the detection signal, and when a difference between the electrical signal of the detection point formed between the plurality of second conductive wires and the one of the plurality of first conductive wires to which the detection signal is input and the standard electrical signal corresponding to the detection point is greater than a preset value, determining that the electrical signal has changed; and
entering a next detection cycle and repeating the steps of a previous detection cycle until all of the plurality of first conductive wires are sequentially input with the detection signal for detection.

In one exemplary embodiment of this disclosure, in the one detection cycle, the detection module is discharged for a preset time, and then the detection signal is input to a target one of the plurality of first conductive wires.

In the smart mat provided by the present disclosure, the pressure sensing layer is located between the first surface layer and the second surface layer, and the first surface layer and the second surface layer form a protection for the pressure sensing layer. In a direction from the first surface layer to the second surface layer, the pressure sensing layer comprises the first electrode layer, the conductive layer, and the second electrode layer that are stacked in sequence. The first electrode layer comprises the plurality of first conductive wires extending in the first direction and spaced apart from each other, and the second electrode layer comprises the plurality of second conductive wires extending in the second direction and spaced apart from each other. By arranging the plurality of conductive strips in one-to-one correspondence with the plurality of first conductive wires, when a first conductive wire of the plurality of first conductive wires corresponding to a pressed position of the smart mat is subjected to a pressure, a pressing force applied by the first conductive wire and a second conductive wire of the plurality of second conductive wire to a corresponding conductive strip of the plurality of conductive strip thereunder increases, and a contact area between the conductive strip, the first conductive wire, and the second conductive wire increases, thereby reducing a resistance between the first conductive wire and the second conductive wire. The detection module is respectively connected to the plurality of first wires and the plurality of second wires. The detection module inputs a detection signal to the plurality of first conductive wires one by one and obtains an electrical signal from the plurality of second conductive wires, thereby outputting a position signal of the first conductive wire and the second conductive wire where a resistance changes among the plurality of first conductive wires and the plurality of second conductive wires. Thus, the pressed position of the smart mat is determined based on the positions of the first conductive wire and the second conductive wire where the resistance changes, so as to feed back the pressed position to a user for reference, thereby identifying a stepping position of a human body and assisting in judging whether a fitness movement is standard.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Obviously, the drawings in the following description are only some embodiments of the present disclosure. For those of ordinary skill in the art, other drawings can be obtained based on these drawings without any creative effort.

FIG. 1 is a schematic diagram of a smart mat provided by an embodiment of the present disclosure.

FIG. 2 is an exploded view of the smart mat provided by the embodiment of the present disclosure.

FIG. 3 is an exploded view of a pressure sensing layer provided by the embodiment of the present disclosure.

FIG. 4 is a schematic diagram of a first electrode layer provided by the embodiment of the present disclosure.

FIG. 5 is a schematic diagram of a second electrode layer provided by the embodiment of the present disclosure.

FIG. 6 is a schematic diagram of a conductive layer provided by the embodiment of the present disclosure.

FIG. 7 is a schematic diagram of an equivalent circuit of the conductive layer provided by the present disclosure.

FIG. 8 is a schematic diagram of an equivalent circuit between a first conductive wire, a second conductive wire, and the conductive layer provided by the present disclosure.

FIG. 9 is a schematic diagram of an equivalent circuit of the first electrode layer provided by the present disclosure.

FIG. 10 is a schematic diagram of another equivalent circuit of the first electrode layer provided by an embodiment of the present disclosure.

FIG. 11 is a schematic diagram illustrating a misjudgment occurring in an equivalent circuit of the first conductive wire and the second conductive wire provided by the present disclosure.

FIG. 12 is a schematic diagram illustrating elimination of misjudgment in the equivalent circuit of the first conductive wire and the second conductive wire provided by the embodiment of the present disclosure.

FIG. 13 is a schematic diagram of the pressure sensing layer and a sampling circuit provided by the embodiment of the present disclosure.

FIG. 14 is a schematic diagram of a second selection switch provided by the embodiment of the present disclosure.

FIG. 15 is a schematic diagram of the pressure sensing layer and a sampling circuit provided by the embodiment of the present disclosure.

FIG. 16 is a schematic diagram of a second selection switch provided by the embodiment of the present disclosure.

### DESCRIPTION OF REFERENCE NUMERALS

110: first surface layer; 120: second surface layer;
200: pressure sensing layer; 210: first electrode layer; 211: first conductive wire; 212: first substrate; 220: second electrode layer; 221: second conductive wire;
222: second substrate; 230: conductive layer; 231: conductive strip; 240: first selection switch; 250: second selection switch;
300: detection circuit;
400: flexible printed circuit cable connector; 401: indicator light; 402:
communication module; 410: sampling circuit;
500: housing; 501: viewing window; 510: first housing; 520: second housing;
600: light shield;
700: battery.

### DETAILED DESCRIPTION OF THE EMBODIMENTS

Exemplary embodiments will now be described more fully with reference to the accompanying drawings. However, these exemplary embodiments can be implemented in many forms and should not be construed as limited to the examples set forth herein. Rather, these embodiments are provided so that this disclosure will be more thorough and complete, and will fully convey the concept of the exemplary embodiments to those skilled in the art.

Furthermore, the described features, structures, or characteristics can be combined in any suitable manner in one or more embodiments. Numerous specific details are provided in the following description to give a thorough understanding of embodiments of this disclosure. However, those skilled in the art will recognize that the technical solutions of this disclosure can be practiced without one or more of the specific details, or other methods, components, apparatuses, steps, etc., can be employed. In other instances, well-known methods, apparatuses, implementations, or operations are not shown or described in detail to avoid obscuring various aspects of this disclosure.

The block diagrams shown in the accompanying drawings are merely functional entities and do not necessarily correspond to physically independent entities. That is, these functional entities can be implemented in software, in one or more hardware modules or integrated circuits, or in different network and/or processor devices and/or microcontroller devices.

The flowcharts shown in the accompanying drawings are merely illustrative and do not necessarily include all content and operations/steps, nor do they necessarily have to be performed in the described order. For example, some operations/steps can be broken down, while others can be combined or partially combined. Therefore, the actual execution order may change depending on the specific circumstances.

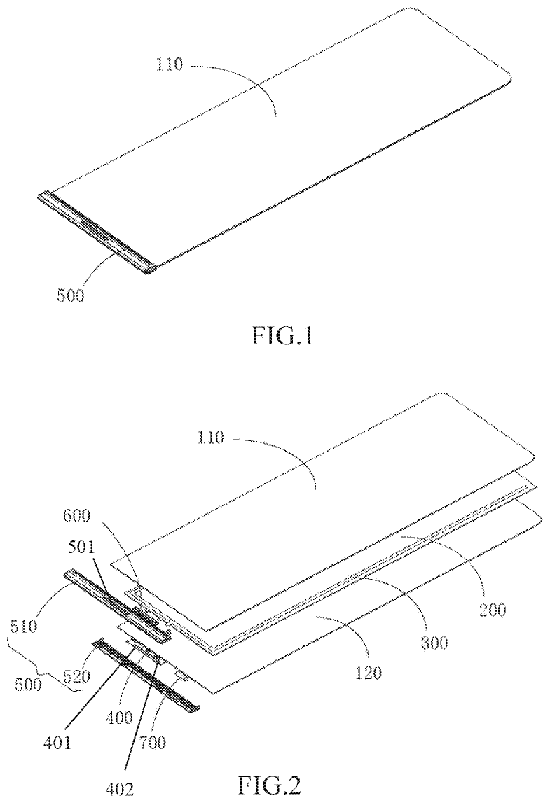

The embodiments of this disclosure first provide a smart mat. As shown in FIGS. 1 to 6, the smart mat comprises a first surface layer 110, a second surface layer 120, a pressure sensing layer 200, and a detection module. The first surface layer 110 and the second surface layer 120 are disposed opposite to each other, and the pressure sensing layer 200 is located between the first surface layer 110 and the second surface layer 120. The pressure sensing layer 200 comprises a first electrode layer 210, a conductive layer 230, and a second electrode layer 220 stacked sequentially. The first electrode layer 210 comprises a plurality of first conductive wires 211 extending along a first direction X and spaced apart from each other. The second electrode layer 220 comprises a plurality of second conductive wires 221 extending along a second direction Y and spaced apart from each other. The first direction X intersects the second direction Y. The conductive layer 230 comprises a plurality of conductive strips 231 extending along the first direction X and spaced apart from each other, and the plurality of conductive strips 231 correspond to the plurality of first conductive wires 211 in a one-to-one correspondence. The detection module is respectively connected to the plurality of first conductive wires 211 and the plurality of second conductive wires 221. The detection module inputs a detection signal to the plurality of first conductive wires 211 one by one and obtains an electrical signal from the plurality of second conductive wires 221, thereby outputting a position signal of a corresponding one of the plurality of first conductive wires 211 and a corresponding one of the plurality of second conductive wires 221 where the electrical signal changes. The electrical signal can be at least one of resistance, voltage, or current.

In the smart mat provided in the present disclosure, the pressure sensing layer 200 is located between the first surface layer 110 and the second surface layer 120, and the pressure sensing layer 200 is protected by the first surface layer 110 and the second surface layer 120. In a direction extending from the first surface layer 110 to the second surface layer 120, the pressure sensing layer 200 comprises the first electrode layer 210, the conductive layer 230, and the second electrode layer 220 stacked sequentially. The first electrode layer 210 comprises the plurality of first conductive wires 211 extending along the first direction X and spaced apart from each other, and the second electrode layer 220 comprises the plurality of second conductive wires 221 extending along the second direction Y and spaced apart from each other. By arranging the plurality of conductive strips 231 in a one-to-one correspondence with the plurality of first conductive wires 211, when a corresponding one of the plurality of first conductive wires 211 corresponding to a pressed point on the smart mat is subjected to a pressure, a corresponding one of the plurality of conductive strips 231 below the corresponding one of the plurality of first conductive wires 211 is subjected to a greater pressing force from the corresponding one of the plurality of first conductive wires 211 and a corresponding one of the plurality of second conductive wires 221, so that a contact area between the corresponding one of the plurality of conductive strips 231, the corresponding one of the plurality of first conductive wires 211, and the corresponding one of the plurality of second conductive wires 221 increases, thereby changing and reducing a resistance between the corresponding one of the plurality of first conductive wires 211 and the corresponding one of the plurality of second conductive wires 221. The detection module is respectively connected to the plurality of first conductive wires 211 and the plurality of second conductive wires 221. The detection module inputs the detection signal to the plurality of first conductive wires 211 one by one and obtains the electrical signal from the plurality of second conductive wires 221. The detection module compares the electrical signal with a standard electrical signal obtained at a detection point corresponding to the pressed point when the smart mat is not pressed, and the detection module outputs the corresponding one of the plurality of first conductive wires 211 and the corresponding one of the plurality of second conductive wires 221 whose resistance changes, so that a position of the corresponding one of the plurality of first conductive wires 211 and the corresponding one of the plurality of second conductive wires 221 where the electrical signal changes determines a pressed position of the smart mat. The pressed position is fed back to a user for reference, thereby identifying a human stepping position and helping to judge whether an exercise movement is standard.

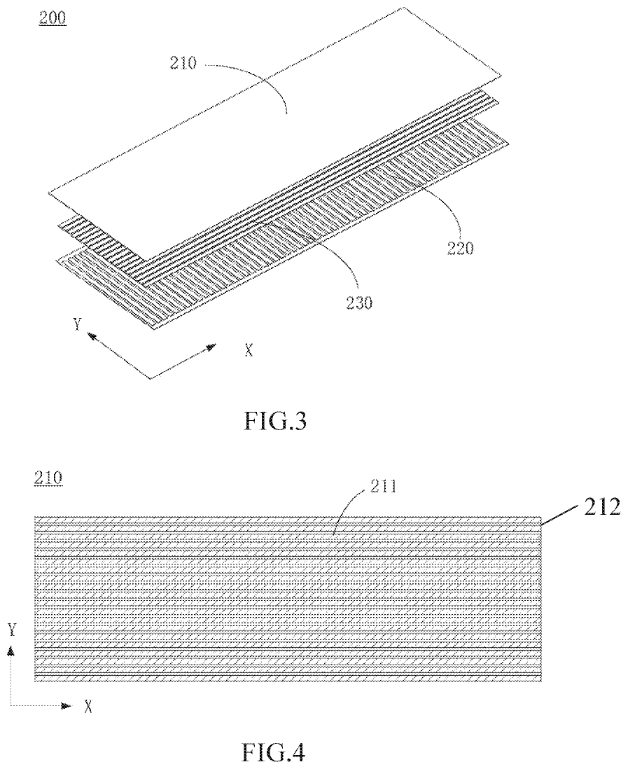

Specifically, as shown in FIGS. 3 to 5, a length of each of the plurality of first conductive wires 211 along the first direction X is greater than a length of each of the plurality of second conductive wires 221 along the second direction Y. Since dimensions of the first electrode layer 210 and the second electrode layer 220 along the first direction X and the second direction Y are the same, the length of each of the plurality of first conductive wires 211 is equal to a length of the second electrode layer 220, and the length of each of the plurality of second conductive wires 221 is equal to a width of the first electrode layer 210, so that a number of the plurality of second conductive wires 221 is greater than a number of the plurality of first conductive wires 211.

In this configuration, the first direction X is perpendicular to the second direction Y, meaning that the first electrode layer 210 and the second electrode layer 220 are rectangular, and the pressure sensing layer 200 formed by the first electrode layer 210 and the second electrode layer 220 is rectangular. Alternatively, an inclined angle between the first direction X and the second direction Y can be less than 90° or greater than 90°. This disclosure does not impose any restrictions on the arrangement of the first direction X relative to the second direction Y.

In one embodiment, the first surface layer 110 and the second surface layer 120 of the smart mat may be made of a thermoplastic polyurethane (TPU) material, and edges of the first surface layer 110 and the second surface layer 120 are sealingly connected together to form a sealed cavity between the first surface layer 110 and the second surface layer 120. The edges of the first surface layer 110 and the second surface layer 120 can be sealingly connected together by insulating cement, sewing, weaving, etc. This disclosure does not impose any limitations on the method for sealingly connecting the first surface layer 110 and the second surface layer 120.

The pressure sensing layer 200 is located between the first surface layer 110 and the second surface layer 120. The first electrode layer 210 can be fixedly connected to the first surface layer 110, and the second electrode layer 220 can be fixedly connected to the second surface layer 120. The materials used for the first surface layer 110 and the second surface layer 120 have good deformation and self-recovery capabilities, so that the first surface layer 110 and the second surface layer 120 can undergo elastic deformation when an external force is applied and can return to their original shape after the external force is removed. This allows the first electrode layer 210 and the second electrode layer 220 to return to their original shape after the external force is removed, thereby restoring a contact area between the first electrode layer 210, the second electrode layer 220, and the conductive layer 230.

The first electrode layer 210 and the first surface layer 110 can be connected by bonding, sewing, or other means, and the second electrode layer 220 and the second surface layer 120 can be connected by bonding, sewing, or other means.

In one embodiment, the smart mat further comprises insulating layers. One of the insulating layers is disposed between the first electrode layer 210 and the first surface layer 110, and another of the insulating layers is disposed between the second electrode layer 220 and the second surface layer 120. The insulating layers provide an insulation performance of the smart mat to prevent electric shock to the user due to leakage from the pressure sensing layer 200. Alternatively, the first surface layer 110 and the second surface layer 120 can be directly made of or made from insulating materials to achieve a same insulation performance.

In one embodiment, as shown in FIG. 3, the first electrode layer 210, the conductive layer 230, and the second electrode layer 220 are sequentially stacked together, so that opposite sides of the conductive layer 230 are electrically connected to the first electrode layer 210 and the second electrode layer 220. The first electrode layer 210, the conductive layer 230, and the second electrode layer 220 can be sequentially stacked and then sewn together as an integrated structure.

As shown in FIG. 4, the first electrode layer 210 comprises a first substrate 212 and the plurality of first conductive wires 211. The plurality of first conductive wires 211 are located on the first substrate 212. The first substrate 212 can be, for example, non-woven fabric, and the plurality of first conductive wires 211 can be, for example, aluminum foil or copper foil to improve the conductivity of the plurality of first conductive wires 211 and reduce an internal resistance of the plurality of first conductive wires 211. Alternatively, the plurality of first conductive wires 211 can be, for example, a printed conductive layer containing carbon powder. The plurality of first conductive wires 211 can be pre-formed on the first substrate 212 by printing, or the plurality of first conductive wires 211 can be bonded to the first substrate 212 by double-sided adhesive.

As shown in FIG. 5, the second electrode layer 220 comprises a second substrate 222 and the plurality of second conductive wires 221. The plurality of second conductive wires 221 are located on the second substrate 222. The second substrate 222 can be, for example, non-woven fabric, and the plurality of second conductive wires 221 can be, for example, aluminum foil or copper foil to improve the conductivity and reduce an internal resistance of the plurality of second conductive wires 221. Alternatively, the plurality of second conductive wires 221 can also be, for example, a printed conductive layer containing carbon powder. The plurality of second conductive wires 221 can be pre-formed on the second substrate 222 by printing, or the plurality of second conductive wires 221 can be bonded to the second substrate 222 by double-sided adhesive.

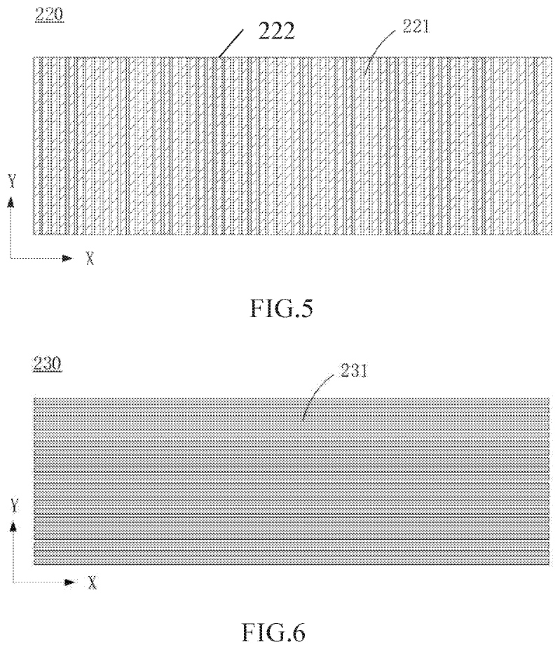

In one embodiment, as shown in FIG. 6, the conductive layer 230 can be made of a conducting carbon film. That is, the plurality of conductive strips 231 are strip-shaped carbon films. When the strip-shaped carbon films are pressed, a contact area between the strip-shaped carbon films, the plurality of first conductive wires 211, and the plurality of second conductive wires 221 increases, so that a resistance value between the strip-shaped carbon films, the plurality of first conductive wires 211, and the plurality of second conductive wires 221 is significantly changed due to being pressed, therefore changing the resistance between the corresponding one of the plurality of first conductive wires 211 and the corresponding one of the plurality of second conductive wires 221 when the strip-shaped carbon films are pressed. The conducting carbon film is relatively thin, so that when the conducting carbon film is used in the smart mat, an overall thickness of the smart mat is not affected, and noticeable bumps are not created, thus improving a user experience.

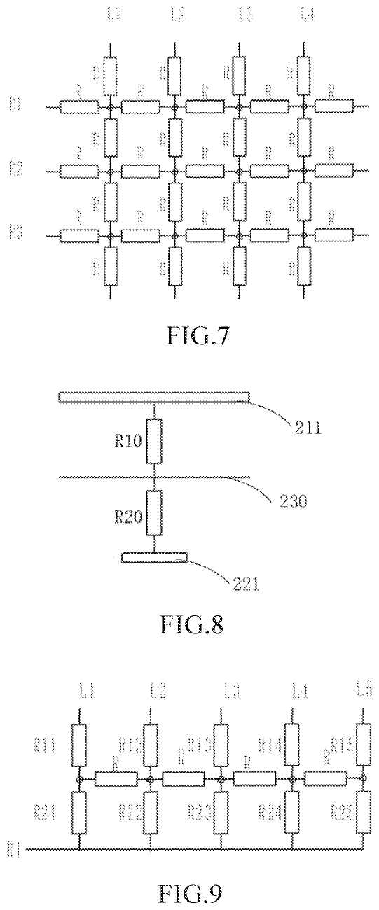

Specifically, as shown in FIG. 7, since the conducting carbon film is also a conductor, any potential change at any point during matrix sampling will inevitably affect an entire conducting carbon film. A resistance of the conducting carbon film being changed due to a pressure is achieved by changing an area of contact resistances along a thickness direction of the smart mat to change a value of the resistance of the conducting carbon film. That is, a resistance at a certain point can be considered a sum of the contact resistances above and below the conducting carbon film. That is, a sum of R10 and R20 as shown in FIG. 8. This change in magnitude is independent of deformation and is only positively correlated with a size of contact areas affected by a force. In FIG. 7, L1, L2, L3, and L4 represent the plurality of first conductive wires 211 arranged sequentially, and R1, R2, and R3 represent the plurality of second conductive wires 221 arranged sequentially. R is an equivalent resistance of the conductive layer 230 between the plurality of first conductive wires 211 and the plurality of second conductive wires 221. In FIG. 8, R10 and R20 represent the contact resistances of the conductive layer 230 between the plurality of first conductive wires 211 and the plurality of second conductive wires 221.

As shown in FIG. 8, an equivalent circuit of the conducting carbon film shows that when columns are energized and observed in rows, due to conductive resistances R of the conducting carbon film, the observed resistance R total=R10+R′, where R′ is a parallel value of the contact resistance R20 and an equivalent resistance on a same plane. Under a condition that R>>R20, R′=R20/n, where R is an approximate average resistance of the conductive carbon films per column and where n is the number of the plurality of second conductive wires. However, a resistance value of R is negatively correlated with the length of each of the plurality of first conductive wires 211, and it is difficult to achieve R>>R20. Therefore, R′=R2/n is not valid in reality. A resistance value of R′ is related to the length of each of the plurality of first conductive wires 211, a conductivity coefficient of the conductive carbon film, and a tightness between the conductive carbon films and the second electrode layer 220 during manufacturing (i.e., R2).

FIG. 9 shows an equivalent circuit for a same row. It can be seen that when compressed, a contact resistance R1X of an upper layer of a corresponding one of the conductive carbon films becomes very small. Due to a presence of the resistance R, there is always a loop from a power supply through the corresponding one of the conductive carbon films to the same row, and an observed resistance at any point will be affected by a compressed point, thus causing misjudgment. Furthermore, because the contact area varies with a manufacturing process, the contact resistance at different points is not fixed. Therefore, a point observed in the same row is actually a minimum observable value for that row, which can cause some areas to be insensitive to pressure. Here, R1X (X=1~5) and R2X (X=1~5) are the contact resistances between the plurality of first conductive wires 211 and the plurality of second conductive wires 221.

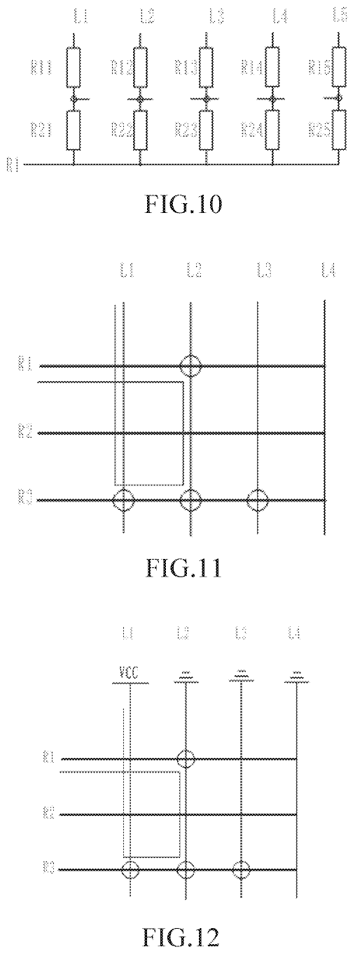

As shown in FIG. 10, this disclosure divides the conducting carbon film into the strip-shaped carbon films independent of each other. A detected resistance R=R1+R2 can eliminate interference between the columns in a transverse direction, thus ensuring that a potential will not crosstalk between a left side and a right side when the plurality of first conductive wires 211 are energized sequentially. This avoids misjudgment caused by an un-compressed point being affected by the compressed point during sampling.

In one embodiment, the conductive carbon film can comprise a plastic film and a conductive carbon powder uniformly distributed in the plastic film. A resistance value of the conductive carbon film can be adjusted by regulating a proportion of the conductive carbon powder. The higher a content of the conductive carbon powder, the stronger conductivity and the lower the resistance value of the conductive carbon film. In other words, the resistance value of the conductive carbon film is related to the contact area between the plurality of first conductive wires 211, the plurality of second conductive wires 221, and the conductive carbon film, as well as the content of the conductive carbon powder in the conductive carbon film. A larger contact area between the plurality of first conductive wires 211, the plurality of second conductive wires 221, and the conductive carbon film results in a lower resistance, and a higher conductive carbon powder content in the conductive carbon film also results in a lower resistance.

Because a resistance change between the conductive carbon film, the first electrode layer 210, and the second electrode layer 220 differs from that of easily creeping materials such as fabrics, a resistance change value of the conductive carbon film caused by pressing is small. The resistance change value primarily occurs through variations in the contact area between an upper conductive metal layer, a lower conductive metal layer, and the conductive carbon film. Furthermore, in a manufacturing process of the conductive carbon film, the conductive carbon powder in a surface of the plastic film cannot be completely uniformly distributed. Therefore, resistance consistency of the conductive carbon film is poor, making a standardized judgment method unsuitable for such inconsistent conditions. This disclosure provides a detection circuit to obtain pre-obtained electrical signals at the detection points formed between the plurality of first conductive wires 211 and the plurality of second conductive wires 221. The pre-obtained electrical signals at the detection points are used as the standard electrical signals for reference. In subsequent detection processes, the electrical signals at the detection points are compared with the standard electrical signals. Changes between the electrical signals and the standard electrical signals are used to determine whether the detection points are pressed. By comparing each of the detection points with itself to improve detection accuracy, a discrepancy in an electrical signal at each of the detection points caused by the manufacturing process of the conductive carbon film (which may result in imperfectly uniform surface carbon powder distribution, leading to misjudgments) can be avoided.

As shown in FIG. 11, circled points represent actual pressed points. During a scanning process, L1 is energized. Due to being pressed, resistances at points (L3, R3), (L2, R3), (L2, R1), and (L1, R3) are reduced, an observation point (L1, R1) is judged as being pressed because of a high level. This leads to misjudgments of non-pressed points due to an influence of the pressed points.

As shown in FIG. 2, the detection module comprises the detection circuit 300. The detection circuit 300 periodically inputs the detection signal to the plurality of first conductive wires 211 in the first electrode layer 210 and samples the plurality of second conductive wires 221 to determine a position of the corresponding one of the plurality of first conductive wires 211 and the corresponding one of the plurality of second conductive wires 221 with decreasing resistance in the plurality of first conductive wires 211 and the plurality of second conductive wires 221.

Specifically, within a detection cycle, a high-level signal is input to the plurality of first conductive wires 211 one by one through the detection module, while a low-level signal is input to the plurality of first conductive wires 211, other than the one of the plurality of first conductive wires 211 currently receiving the high-level signal. Then, a sampling circuit 410 determines whether there are any conductive wires with reduced resistance in a circuit of the plurality of second conductive wires 221. If so, it is determined that a position of one of the plurality of first conductive wires 211 receiving the high-level signal and one of the plurality of second conductive wires 221 where reduced resistance was detected is pressed. If not, it is determined that the position one of the plurality of first conductive wires 211 receiving the high-level signal is not pressed. This process is repeated until all of the plurality of first conductive wires 211 have been sequentially input with the high-level signal for detection. After all of the plurality of first conductive wires 211 have been sequentially input with the high-level signal for detection, one detection cycle is completed. After completing one detection cycle, the detection module outputs information of the pressed position. Then, a next detection cycle begins, and this cycle repeats, enabling the smart mat to monitor and provide feedback on the pressed position in real time during use.

As shown in FIG. 12, the detection module inputs the high-level signal to the plurality of first conductive wires 211 one by one, while the detection module inputs the low-level signal to the plurality of first conductive wires 211, other than the one of the plurality of first conductive wires 211 that is currently input with the high-level signal. At this time, since the point (L2, R1) is input with the low-level signal, a level on a row R1 will also be a low level, which is judged as not being pressed.

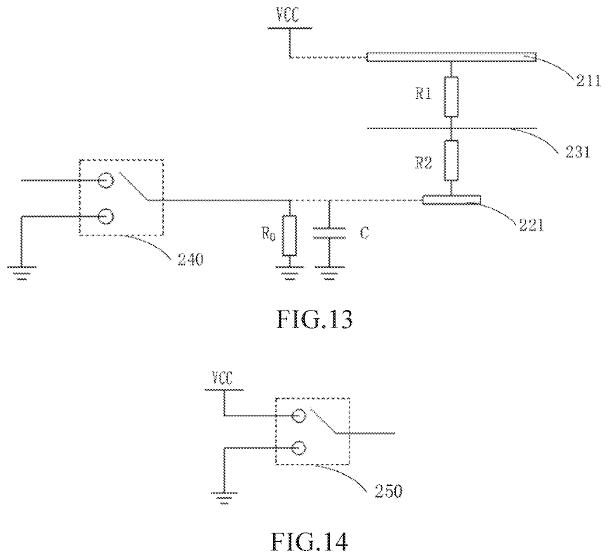

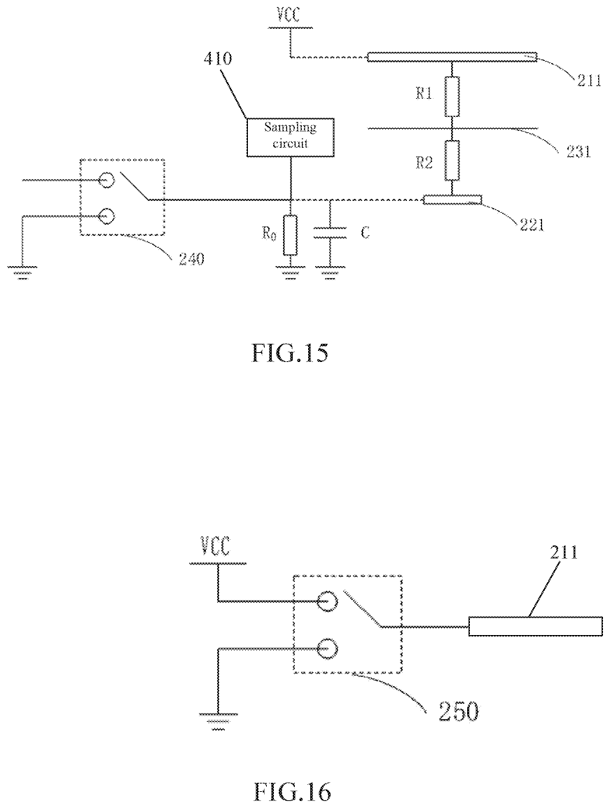

In one embodiment, as shown in FIG. 13, the detection module comprises a plurality of acquisition terminal circuits, and the plurality of acquisition terminal circuits are connected to the plurality of second conductive wires 221 in a one-to-one correspondence. Each of the plurality of acquisition terminal circuits comprises a first selection switch 240, and the first selection switch 240 comprises a throw terminal, a first wire connecting terminal, and a second wire connecting terminal. The throw terminals are connected to the plurality of second conductive wires 221, the first wire connecting terminal is configured to be connected to the sampling circuit 410, and the second wire connecting terminal is grounded. The first selection switch 240 controls the throw terminal to be connected to the first wire connecting terminal or the second wire connecting terminal. Within one detection cycle, when the throw terminal is connected to the first wire connecting terminal, the sampling circuit 410 is connected to a corresponding one of the plurality of second conductive wires 221, enabling sampling of the plurality of second conductive wires 221. When the throw terminal is connected to the second wire connecting terminal, the corresponding one of the plurality of second conductive wires 221 is connected to ground, discharging any residual charge in the circuit and preparing for a next sampling cycle.

As shown in FIG. 13, each of the plurality of acquisition terminal circuits also comprises a sample hold capacitor C. First terminals of the sample hold capacitors C are connected to the plurality of second conductive wires 221 and the throw terminals, and second terminals of the sample hold capacitors C are grounded. The sample hold capacitors C provide voltage stabilization, ensuring that a voltage on the plurality of second conductive wires 221 remains stable at a target voltage during detection, thereby improving accuracy of detection results. Furthermore, when the throw terminal is connected to the second wire connecting terminal, a discharge circuit is formed to discharge the sample hold capacitor C before the next sampling cycle. A discharge time can be set according to a size of a hold capacitor and a parasitic capacitor.

As shown in FIG. 13, each of the plurality of acquisition terminal circuits also comprises a sampling resistor R0. First ends of the sampling resistors R0 are connected to the plurality of second conductive wires 221 and the throw terminals, and second ends of the sampling resistors R0 are grounded. By setting the sampling resistors R0, the sampling circuit 410 obtains a voltage of the sampling resistor R0 during sampling. A voltage change of the sampling resistor R0 can be used to determine a resistance change between the plurality of first conductive wires 211 and the plurality of second conductive wires 221, thereby determining whether the positions corresponding to the plurality of first conductive wires 211 and the plurality of second conductive wires 221 are being pressed.

In one embodiment, as shown in FIG. 14, the detection module further comprises a plurality of second selection switches 250, and the plurality of second selection switches 250 are connected to the plurality of first conductive wires 211. Each of the plurality of second selection switches 250 comprises a throw terminal, a first wire connecting terminal, and a second wire connecting terminal. The throw terminals are connected to the plurality of first conductive wires 211, the first wire connecting terminals are configured to be connected to a drive circuit, and the second wire connecting terminals are grounded.

Within one detection cycle, the high-level signal is sequentially input to the plurality of first conductive wires 211 through the detection module. The throw terminal and the first wire terminal of one of the plurality of second selection switches 250 that is connected to one of the plurality of first conductive wires 211 are connected, resulting in the high-level signal (VCC) input to the one of the plurality of first conductive wires 211. The throw terminals and the second wire terminals of the others of the plurality of second selection switches 250 that are connected to the others of the plurality of first conductive wires 211 are connected, resulting in the low-level signal input to the others of the plurality of first conductive wires 211. By controlling the plurality of second selection switches 250 connected to the plurality of first conductive wires 211 one by one, the high-level signal is sequentially input to the plurality of first conductive wires 211 for detection.

In one embodiment, the smart mat further comprises a communication module 402 connected to the detection module, and the communication module 402 is configured to transmit detection data acquired by the detection module to a target terminal.

Specifically, data collected by the detection circuit is quantified and then communicated wirelessly or via wired means with a mobile phone or other electronic terminal to provide feedback on stepping location information of the user. The communication method can be, for example, Bluetooth, wireless fidelity (Wi-Fi), 2.4G, or other wireless means, or Ethernet, universal serial bus (USB), or other wired means. This disclosure does not impose any limitations on the manner by which the data is communicated.

In one embodiment, as shown in FIGS. 1 and 2, the smart mat further comprises a housing 500, and the housing 500 is formed by a first housing 510 being buckled to a second housing 520. The first housing 510 is buckled to the second housing 520 to form an accommodating space, and a flexible printed circuit cable connector 400 is accommodated in the accommodating space. The housing 500 provides protection for the flexible printed circuit cable connector 400.

A battery 700 is disposed in the accommodating space of the housing 500, and the battery 700 supplies power to the flexible printed circuit cable connector 400 to supply power to the entire detection circuit 300. The battery 700 can be a removable secondary battery for easy replacement and charging. Alternatively, the battery 700 can be a non-removable secondary battery that is charged via a charging port.

The housing 500 has a viewing window 501, and the flexible printed circuit cable connector 400 has an indicator light 401. A light signal of the indicator light 401 can be observed through the viewing window 501. A light shield 600 is detachably or openably mounted on the viewing window 501 to facilitate observation of the light signal of the indicator light 401. The light shield 600 also prevents the light signal of the indicator light 401 from affecting vision of the user for extended periods. The light signal can be a battery power signal of the battery 700, a signal indicating whether a circuit board is working properly, etc. This disclosure does not limit how the light signal can be used.

Embodiments of this disclosure also provide a multi-point detection method for the smart pad. The multi-point detection method for a smart mat comprises:
Step S100: providing the smart mat provided in the above embodiments;
Step S200: obtaining the standard electrical signals of the detection point formed between the plurality of first conductive wires 211 and the plurality of second conductive wires 221 by the detection module when the smart mat is not pressed;
in one detection cycle, step S310: inputting the detection signal to one of the plurality of first conductive wires 211 through the detection module; step S320: obtaining, through the detection module, one of the plurality of second conductive wires 221 whose electrical signal changes among the plurality of second conductive wires 221 and the one of the plurality of first conductive wires 211 that is input with the detection signal; and
in a next detection cycle, repeating the steps of the previous detection cycle (steps S310 and S320) until all of the plurality of first conductive wires 211 are sequentially input with the detection signal for detection.

Specifically, the smart mat comprises the first surface layer 110, the second surface layer 120, the pressure sensing layer 200, and the detection module. The first surface layer 110 and the second surface layer 120 are disposed opposite to each other, and the pressure sensing layer 200 is located between the first surface layer 110 and the second surface layer 120. The pressure sensing layer 200 comprises the first electrode layer 210, the conductive layer 230, and the second electrode layer 220 stacked sequentially. The first electrode layer 210 comprises the plurality of first conductive wires 211 extending along the first direction X and spaced apart from each other, and the second electrode layer 220 comprises the plurality of second conductive wires 221 extending along the second direction Y and spaced apart from each other. The conductive layer 230 comprises the plurality of conductive strips 231 extending along the first direction X and spaced apart from each other, and the plurality of conductive strips 231 correspond to the plurality of first conductive wires 211 in a one-to-one correspondence. The detection module is respectively connected to the plurality of first conductive wires 211 and the plurality of second conductive wires 221. For more specific details of the smart pad, please refer to the detailed description in the embodiments of the above-described smart pad, which will not be repeated here.

Specifically, in the step S200, before performing a detection process, the smart mat is kept in a non-pressed state at all locations; then, the pre-obtained electrical signals of the detection points formed between the plurality of first conductive wires 211 and the plurality of second conductive wires 221 are obtained by the detection circuit 300, and the pre-obtained electrical signals of the detection points between the plurality of first conductive wires 211 and the plurality of second conductive wires 221 are used as the standard electrical signals for reference. The pre-obtained electrical signal can be at least one of resistance, voltage, or current.

Specifically, in the step S310, a detection signal is input to the one of the plurality of first conductive wires 211 through the detection module, and the high-level signal is input to the one of the plurality of first conductive wires 211 while the low-level signal is input to the others of the plurality of first conductive wires 211.

As shown in FIG. 14, the detection module further comprises the plurality of second selection switches 250, and the plurality of second selection switches 250 are connected to the plurality of first conductive wires 211 in a one-to-one correspondence. Each of the plurality of second selection switches 250 comprises the throw terminal, the first wire connecting terminal, and the second wire connecting terminal. The throw terminals are connected to the plurality of second conductive wire 221, the first wire connecting terminal is configured to be connected to the drive circuit, and the second wire connecting terminal is grounded. During one detection cycle, when the high-level signal is input sequentially to the plurality of first conductive wires 211 through the detection module, the throw terminal and the first wire connecting terminal of one of the plurality of second selection switches 250 connected to the one of the plurality of first conductive wires 211 is connected to each other, resulting in the high-level signal (VCC) being input to the one of the plurality of first conductive wires 211. The throw terminals and the second wire connecting terminals of the others of the plurality of second selection switches 250 connected to the others of the plurality of first conductive wires 211 are connected to each other, resulting in the low-level signal being input to the others of the plurality of first conductive wires 211. By controlling the plurality of second selection switches 250 connected to the plurality of first conductive wires 211 one by one, the high-level signal can be input sequentially to each of the plurality of first conductive wires 211 for detection.

Specifically, in the step S320, the detection circuit 300 of the detection module samples the plurality of second conductive wires 221 to determine one of the plurality of second conductive wires 221 whose electrical signal changes among the plurality of second conductive wires 221 and the one of plurality of first conductive wires 211 input with the high-level signal, thereby outputting position information of the one of plurality of first conductive wires 211 input with the high-level signal and the one of the plurality of second conductive wires 221 whose electrical signal changes.

When determining whether the electrical signal has changed, the electrical signal at a specific one of the detection points is compared with a pre-obtained reference value of the standard electrical signal at the specific one of the detection points in the non-pressed state. For example, when a difference between the specific one of the detection points and the pre-obtained reference value exceeds 5% of the pre-obtained reference value, it can be determined that the specific one of the detection points has been pressed, and pressed information of the specific one of the detection points is output. Alternatively, compression can also be determined when the difference between the specific one of the detection points and the pre-obtained reference value exceeds 1%, 2%, 3%, 4%, 6%, 10%, etc. of the pre-obtained reference value. This disclosure does not impose any limitations on when compression is determined.

As shown in FIG. 13, the detection module comprises a plurality of acquisition terminal circuits, and the plurality of acquisition terminal circuits are connected to the plurality of second conductive wires 221 in a one-to-one correspondence. Each of the plurality of acquisition terminal circuits comprises the first selection switch 240, and the first selection switch 240 comprises the throw terminal, the first wire connecting terminal, and the second wire connecting terminal. The throw terminals are connected to the plurality of second conductive wires 221, the first wire connecting terminal is configured to be connected to the sampling circuit 410, and the second wire connecting terminal is grounded. The first selection switch 240 controls the throw terminal to be connected to the first wire connecting terminal or the second wire connecting terminal. Within one detection cycle, when the throw terminal is connected to the first wire connecting terminal, the sampling circuit 410 is connected to a corresponding one of the plurality of second conductive wires 221, enabling sampling of the plurality of second conductive wires 221. When the throw terminal is connected to the second wire connecting terminal, the corresponding one of the plurality of second conductive wires 221 is connected to ground, discharging any residual charge in the circuit and preparing for a next sampling cycle.

In one embodiment, as shown in FIG. 13, each of the plurality of acquisition terminal circuits also comprises the sample hold capacitor C. The first terminals of the sample hold capacitors C are connected to the plurality of second conductive wires 221 and the throw terminals of the first selection switches 240, and second terminals of the sample hold capacitors C are grounded. The sample hold capacitors C provide voltage stabilization, ensuring that the voltage on the plurality of second conductive wires 221 remains stable at the target voltage during detection, thereby improving accuracy of detection results. Furthermore, when the throw terminal of the first selection switches 240 is connected to the second wire connecting terminal of the first selection switches 240, the discharge circuit is formed. In one detection cycle, the throw terminal of the first selection switches 240 is connected to the second wire connecting terminal of the first selection switches 240 to discharge the sample hold capacitor C for the discharge time. The discharge time can be set according to a size of a hold capacitor and a parasitic capacitor. After discharging the sample hold capacitor C, the high-level signal is input to the one of the plurality of first conductive wires 211, and the low-level signal is input to the others of the plurality of first conductive wires 211.

As shown in FIG. 13, each of the plurality of acquisition terminal circuits also comprises the sampling resistor R0. First ends of the sampling resistors R0 are connected to the plurality of second conductive wires 221 and the throw terminals, and second ends of the sampling resistors R0 are grounded. By setting the sampling resistors R0, the sampling circuit 410 obtains a voltage of the sampling resistor R0 during sampling. A voltage change of the sampling resistor R0 can be used to determine a resistance change between the plurality of first conductive wires 211 and the plurality of second conductive wires 221, thereby determining whether the positions corresponding to the plurality of first conductive wires 211 and the plurality of second conductive wires 221 are being pressed.

The smart mat disclosed herein can also be a mattress. When a user rests or sleeps on the mattress, the smart mat can locate the pressed points on the mattress and then analyze the located pressed points to obtain information about sleep of the user.

Other embodiments of this disclosure will readily occur to those skilled in the art upon consideration of the specification and practice of the invention disclosed herein. This application is intended to cover any variations, uses, or adaptations of this disclosure that follow the general principles of this disclosure and include common knowledge or customary techniques in the art not disclosed herein. The specification and examples are to be considered exemplary only, and the true scope and spirit of this disclosure are indicated by the following claims.

It should be understood that this disclosure is not limited to the precise structures described above and shown in the accompanying drawings, and various modifications and changes can be made without departing from its scope. The scope of this disclosure is limited only by the appended claims.

What is claimed is:

1. A smart mat, comprising:
a first surface layer,
a second surface layer,
a pressure sensing layer, and
a detection module, wherein:
the first surface layer and the second surface layer are disposed opposite to each other,
the pressure sensing layer is located between the first surface layer and the second surface layer,
the pressure sensing layer comprises a first electrode layer, a conductive layer, and a second electrode layer stacked sequentially,
the first electrode layer comprises a plurality of first conductive wires extending along a first direction and spaced apart from each other,
the second electrode layer comprises a plurality of second conductive wires extending along a second direction and spaced apart from each other,
the first direction intersects the second direction,
the conductive layer comprises a plurality of conductive strips extending along the first direction and spaced apart from each other,
the plurality of conductive strips correspond to the plurality of first conductive wires in a one-to-one correspondence,
the detection module is respectively connected to the plurality of first conductive wires and the plurality of second conductive wires, and
the detection module is configured to input a detection signal to the plurality of first conductive wires one by one and obtain an electrical signal from the plurality of second conductive wires, thereby outputting a position signal of a corresponding one of the plurality of first conductive wires and a corresponding one of the plurality of second conductive wires where the electrical signal changes.

2. The smart mat according to claim 1, wherein:
the detection module inputs the detection signal to the plurality of first conductive wires one by one through, within a detection cycle, the detection module inputting a high-level signal to the plurality of first conductive wires one by one and inputting a low-level signal to remaining ones of the plurality of first conductive wires other than one of the plurality of first conductive wires input with the high-level signal.

3. The smart mat according to claim 1, wherein:
the detection module comprises a plurality of acquisition terminal circuits,
the plurality of acquisition terminal circuits are connected to the plurality of second conductive wires in a one-to-one correspondence,
the plurality of acquisition terminal circuits comprise a plurality of first selection switches,
the plurality of first selection switches comprise a plurality of throw terminals, a plurality of first wire connecting terminals, and a plurality of second wire connecting terminals,
the plurality of throw terminals are connected to the plurality of second conductive wires,
the plurality of first wire connecting terminals are configured to be connected to a sampling circuit, and
the plurality of second wire connecting terminals are grounded.

4. The smart mat according to claim 3, wherein:
the plurality of acquisition terminal circuits also comprise a plurality of sample hold capacitors,
first terminals of the plurality of sample hold capacitors are connected to the plurality of second conductive wires and the plurality of throw terminals, and
second terminals of the plurality of sample hold capacitors are grounded.

5. The smart mat according to claim 3, wherein:
the plurality of acquisition terminal circuits also comprise a plurality of sampling resistors,
first ends of the plurality of sampling resistors are connected to the plurality of second conductive wires and the plurality of throw terminals, and
second ends of the plurality of sampling resistors are grounded.

6. The smart mat according to claim 1, wherein:
the detection module comprises a plurality of second selection switches,
the plurality of second selection switches are connected to the plurality of first conductive wires,
the plurality of second selection switches comprise a plurality of throw terminals, a plurality of first wire connecting terminals, and a plurality of second wire connecting terminals,
the plurality of throw terminals are connected to the plurality of first conductive wires,
the plurality of first wire connecting terminals are configured to be connected to a drive circuit, and
the plurality of second wire connecting terminals are grounded.

7. The smart mat according to claim 1, comprising:
a communication module, wherein:
the communication module is connected to the detection module, and
the communication module is configured to transmit detection data obtained by the detection module to a target terminal.

8. The smart mat according to claim 1, wherein:
lengths of the plurality of first conductive wires along the first direction are greater than lengths of the plurality of second conductive wires along the second direction.

9. The smart mat according to claim 1, wherein:
a number of the plurality of conductive strips is the same as that of the plurality of first conductive wires.

10. The smart mat according to claim 1, wherein:
the conductive layer is a conductive carbon film, and
the conductive carbon film is divided into a plurality of conductive carbon strips to serve as the plurality of conductive strips.

11. A multi-point detection method for a smart mat, comprising:
providing the smart mat, wherein the smart mat comprises a first surface layer, a second surface layer, a pressure sensing layer, and a detection module, the first surface layer and the second surface layer are disposed opposite to each other, the pressure sensing layer is located between the first surface layer and the second surface layer, the pressure sensing layer comprises a first electrode layer, a conductive layer, and a second electrode layer stacked sequentially, the first electrode layer comprises a plurality of first conductive wires extending along a first direction and spaced apart from each other, the second electrode layer comprises a plurality of second conductive wires extending along a second direction and spaced apart from each other, the first direction intersects the second direction, the conductive layer comprises a plurality of conductive strips extending along the first direction and spaced apart from each other, the plurality of conductive strips correspond to the plurality of first conductive wires in a one-to-one correspondence, and the detection module is respectively connected to the plurality of first conductive wires and the plurality of second conductive wires;
obtaining a standard electrical signal of a detection point formed between the plurality of first conductive wires and the plurality of second conductive wires by the detection module when the smart mat is not pressed;
in one detection cycle, inputting a detection signal to one of the plurality of first conductive wires through the detection module, obtaining, through the detection module, one of the plurality of second conductive wires whose electrical signal changes among the plurality of second conductive wires and the one of the plurality of first conductive wires that is input with the detection signal, and when a difference between the standard electrical signal of the detection point formed between the plurality of second conductive wires and the one of the plurality of first conductive wires to which the detection signal is input and the standard electrical signal corresponding to the detection point is greater than a preset value, determining that the standard electrical signal has changed; and
entering a next detection cycle and repeating the steps of a previous detection cycle until all of the plurality of first conductive wires are sequentially input with the detection signal for detection.

12. The multi-point detection method for the smart mat according to claim 11, wherein:
in the one detection cycle, the detection module is discharged for a preset time, and then the detection signal is input to a target one of the plurality of first conductive wires.
